(19) United States
(12) Patent Application Publication
(10) Pub. No.: US 2016/0082873 A1
(43) Pub. Date: Mar. 24, 2016

(54) Reusable Absorbent Insert for a Vehicle Beverage Holder

(71) Applicants: Roger S. Eiler, El Cajon, CA (US); Dalton A. Eiler, El Cajon, CA (US); Cassidy A.-N. Eiler, El Cajon, CA (US)

(72) Inventors: Roger S. Eiler, El Cajon, CA (US); Dalton A. Eiler, El Cajon, CA (US); Cassidy A.-N. Eiler, El Cajon, CA (US)

(21) Appl. No.: 14/854,151

(22) Filed: Sep. 15, 2015

Related U.S. Application Data
(60) Provisional application No. 62/054,635, filed on Sep. 24, 2014.

(51) Int. Cl. B60N 3/10; B65D 23/06

(52) U.S. Cl. CPC B60N 3/10; B65D 23/06

(57) ABSTRACT

The present invention is a reusable absorbent insert for a vehicle beverage holder. The absorbent insert comprises an open cell matrix material having a beverage container contact surface, a beverage holder contact surface and a perimeter edge. The insert is provided in a shape that fits within the base of a vehicle beverage holder and has at least one tab along its perimeter edge to enable easy placement, removal and replacement of the absorbent insert in the vehicle beverage holder. The present invention also encompasses a reusable absorbent sleeve and band that fits about a beverage container before it is placed in a vehicle beverage holder.

### CROSS-REFERENCE TO RELATED APPLICATIONS

This application claims priority from provisional patent application Ser. No. 62/054,635 filed 24 Sep. 2014.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC

Not applicable

### TECHNICAL FIELD

The present invention relates to devices that absorb moisture from the exterior of a beverage container resulting from the temperature difference between the environment and the beverage in a container. More specifically, to a reusable absorbent insert for a vehicle beverage holder.

### BACKGROUND OF THE INVENTION

A vast majority of soft drinks, fruit juices, beer, wine coolers and other consumable beverages are sold in cans, bottles and other like containers which have been cooled either by refrigeration or immersion in a cooler filled with ice. Even if the container is carefully dried, condensation will rapidly form on its surface because of the temperature differential between the cooled container and the ambient air. The volume of condensation can increase significantly if the humidity is high. This becomes a problem when the container is left on a surface that is susceptible to water damage. Over the years a variety of coasters have been developed to protect surfaces from beverage container condensation.

U.S. Pat. No. 2,004,166 to Low discloses a coaster having two layers of liquid-absorbent blotting paper, separated by an intervening glue film. The upper layer absorbs condensation from the outer surface of the beverage container while the lower layer absorbs water that may occur on the table surface. Unfortunately, blotting paper is limited on the amount of water it can retain and the coaster is not reusable.

U.S. Pat. No. 2,688,858, to Cosmetto and U.S. Pat. No. 3,363,869 to Blundell disclose coasters that have a generally circular plastic base and a central portion that receives a replaceable absorbent disk held in place by a plastic grid. The plastic grid provides a degree of aeration to assist in the disposal of condensation. Unfortunately, this configuration requires the replacement of an absorbent disk following each use.

Advancement over the reusable coaster is described in U.S. Pat. No. 4,978,566 to Scheurer et al. In this configuration, a woven polymeric fabric encases an absorbent material. The polymeric fabric permits moisture to drain into the absorbent layer while preventing the development of a partial vacuum that often causes the coaster to stick to the bottom of the beverage container.

Unfortunately, the polymeric fabric resists compressibility making it difficult to dispense the water retained by the coaster and can interfere with the ability of the coaster to retain its relatively planar configuration.

U.S. Pat. No. 6,695,272 describes a coaster for a vehicle beverage holder having a number of layers wherein one layer is impregnated with and air freshener. However, the coaster having this configuration may become difficult to remove from the vehicle beverage holder after becoming saturated with fluid requiring a pointed object for removal. In addition, the fragrance will emit effectively for a set period of time and its life expectancy is substantially reduced when it is emitted continuously.

Therefore, there is a need for a reusable device that effectively absorbs moisture or other fluid emitted from a beverage container in a vehicle beverage holder; can be easily removed and replaced within the vehicle beverage holder; retains its relative shape; and from which absorbed fluid can be easily removed.

### SUMMARY OF THE INVENTION

The present invention is a reusable absorbent insert for a vehicle beverage holder. The absorbent insert comprises an open cell matrix material having a beverage container contact surface, a beverage holder contact surface and a perimeter edge. The insert is provided in a shape that fits within the base of a vehicle beverage holder and has at least one tab along its perimeter edge to enable easy placement, removal and replacement in the vehicle beverage holder.

In one embodiment, the open cell matrix material is synthetic chamois.

In another embodiment, open cell matrix material further comprises a moisture barrier on its beverage holder contact surface.

In yet another embodiment, the absorbent insert further comprises a flexible polymer perimeter edge to maintain the insert in a relatively planar configuration and to reduce folding. In this configuration, the at least one tab may be provided within the flexible polymer perimeter edge.

A second aspect of the invention is an absorbent sleeve for a beverage container and vehicle beverage holder. The absorbent sleeve comprises an open cell matrix material with an inner beverage container contact surface, an outer beverage holder contact surface, a base and an upper perimeter edge. The sleeve is provided in a shape that fits about a beverage container and within a vehicle beverage holder. The outer beverage contact surface has a moisture barrier and the upper perimeter edge has at least one tab to enable easy placement on and removal from a beverage container and/or placement in or removal from a vehicle beverage holder.

In one embodiment of this aspect of the invention, the absorbent sleeve further comprises a flexible polymer edge on the upper perimeter edge to prevent the sides of the sleeve from collapsing and help maintain a semi-cylindrical configuration.

In another embodiment, the moisture barrier has an open cell matrix material contact surface and an outer surface. In one configuration, the outer surface is textured for better gripping.

A third aspect of the invention is an absorbent band for a beverage container and a vehicle beverage holder. The absorbent band comprises an open cell matrix material with an inner beverage container contact surface, an outer beverage holder contact surface, a top perimeter edge and a bottom perimeter edge. The band is provided in a shape that fits about a beverage container and within a vehicle beverage holder and has a moisture barrier on the outer beverage holder contact surface.

In one embodiment, the absorbent band further comprises a flexible polymer edge on at least one of the perimeter edges to maintain the absorbent band in a semi-cylindrical shape.

In another embodiment, the moisture barrier has an open cell matrix contact surface and an outer surface. In one configuration, the outer contact surface may be textured for better gripping. In yet another embodiment, the absorbent band further comprises at least one strap, each having two ends affixed to the upper perimeter edge about 180 to about 270 degrees distant from the other. This strap may be looped over the top of the beverage container to maintain the absorbent band in place during use.

In each aspect of the present invention, the open cell matrix material may be provided with a plurality of apertures that increases surface area for absorption and evaporation of fluid. It may also comprise activated charcoal to absorb compounds that produce odors or an antibacterial agent such as a silver compound. Alternatively, or in addition, it may also comprise a fragrance that emits an odor continuously or that is activated by moisture.

### DESCRIPTION OF THE FIGURES

Not applicable

### DETAILED DESCRIPTION

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail.

The term “absorbent” as used herein in reference to the material utilized to prepare the insert, sleeve and band of the present invention refers to the material's ability to sequester or take in a volume of fluid. The absorbent material acts like a sponge to draw in liquid from a surface and to release the fluid when compressed.

The term “open cell matrix” as used herein refers to a material which is comprised predominantly of interconnecting cellular voids. For example, a polymer foam material may be prepared as an open cell or closed cell matrix. In a closed cell matrix the polymer foam resists absorption of liquids because there are no open cellular voids to receive the fluid. Conversely, with an open cell matrix, fluid is able to be absorbed into interconnected cellular voids.

The term “silver compound” as used herein in reference to antibacterial agents are a group of compounds that contain silver such as silver sulfadiazine, silver nitrate and silver proteinate. This group includes metallic silver such as silver nanoparticles.

The present invention is a reusable absorbent insert for a vehicle beverage holder comprising an open cell matrix material with a beverage container contact surface, a beverage holder contact surface and a perimeter edge. The insert is provided in a shape that fits within the base of the vehicle beverage holder and having at least one tab along the perimeter edge to enable easy placement, removal and replacement of the absorbent insert in the vehicle beverage holder.

### 1. Matrix

The open cell matrix utilized with the present invention may be made of a variety of materials that readily absorb fluid at volumes exceeding 5 times the materials weight, easily release the absorbed fluid when the material is compressed and retain their structural integrity following continued use. One type of material that may be utilized with the present invention is synthetic chamois. Synthetic chamois is made of a nonwoven fabric, usually composed of 50%-80% viscose and 20%-50% polyester. This material absorbs about 17 times its weight in aqueous liquid. Another type of synthetic chamois is made of a non-woven air-spun viscose containing microfibers (0.01-0.02 denier) and is composed of 70-80% polyester and 20-30% nylon polymide. Companies that produce these type of open cell matrix material include www.globalsources.com (Singapore, Malasia), Ningbo Fuhao Import & Export Trading Co. Ltd. (Ningbo, China) Shenzhen Newclean Trade Co., Ltd. (Shenzhen, China), www.raglady.com (Baltimore, Md.), and www.swimoutlet.com (West Chester, Ohio).

This material can be purchased in large volume rolls that are cut into desired lengths to prepare the inserts. The size and shape will depend. on the size and shape of the vehicle beverage holder in which the insert will be used. While moss beverage holders are cylindrical in shape the insert of the present invention may be prepared in any size and shape sufficient to accomplish its purpose.

The material is usually provided in a standard thickness that may vary from about 2 mm to about 4 mm in thickness. The present invention may utilize one or more layers of this material to absorb additional fluid that may not be possible with a single sheet. In this configuration, the multiple sheets may be sewn together or affixed along their perimeter edge by a variety of methods known to those in the art, such as for example a flexible polymer as discussed below. Alternatively, the open cell matrix material may be prepared in number of different thicknesses. This will eliminate the need to affix multiple sheet together reducing manufacturing costs.

The open cell matrix may further comprise a regular pattern of small apertures. These apertures provide additional surface area to allow the matrix to more efficiently adsorb fluid from the beverage container or release absorbed fluid. The size of the apertures may range from 1 to several millimeters. Preferably the diameter is from 1 to 5 millimeters. The pattern may be dense comprising as many as 25, 1 millimeter apertures per square centimeter to as few as 1 aperture per square centimeter. The apertures may be provided in a variety of shapes. For example, the apertures may be circular, triangular, rectangular, square-shaped, star-shaped or any combination thereof.

In one embodiment, a moisture barrier may be provided on one side of the open cell matrix. The moisture barrier is provided to reduce the amount of moisture that may be transferred to the user or beverage holder during use. Preferably, the moisture barrier is provided on the vehicle beverage holder side of the open cell matrix and may be affixed by a variety of methods known to those skilled in the art including adhesive and fusion. The moisture barrier may be made from a variety of polymers that repel aqueous fluids. Preferably, the polymer is thin and flexible and adhered to the matrix by a method that allows the polymer to maintain integrity without tearing or separating from the matrix when the matrix is periodically compressed to remove excess moisture. For example, the polymer may be made of a variety of plastics known to those skilled in the art including, for example, polypropylene or polyethylene.

In another embodiment, the open cell matrix may be impregnated with agents that reduce bacterial growth, absorb compounds that produce undesirable odors and/or emit a desirable fragrance. When fluid remains in a vehicle beverage holder or an absorbent insert, the fluid can become a growth medium for bacteria. A variety of methods of impregnating agents into a matrix are known in the art. One method for impregnating polymeric particles that are then used to prepare a fused sheet is described in U.S. Pat. No. 4,735,626. Simliarly, the present invention may infuse these same particles with one of more agents and then impregnated them into the open cell matrix material.

Antibacterial agents may be impregnated into the open cell matrix to interfere with or prevent bacterial growth. One of more antibacterial agents may be infused into a polymeric carrier that is permanently impregnated into the open cell matrix. The infused polymeric carrier can leach antibacterial agents into the matrix in the presence of moisture. While a variety of anti-bacterial agents known. to those skilled in the art may be utilized, silver containing compounds have shown particular promise. These compounds include for example silver sulfadiazine, silver nitrate, silver proteinate and silver zeolite. Silver metal in the form of silver nanoparticles may also be impregnated into the open cell matrix.

During growth, bacteria produce compounds that create undesirable odors. Even if the bacteria are eliminated these compounds can remain. To eliminate these compounds and the odors that they create, the open cell matrix may be impregnated with charcoal. Small beads or micro-beads of charcoal or activated charcoal may be fused or adhered within the matrix. In one embodiment, the charcoal or activated charcoal is coated with a polymer that does not block the pores and may be utilized to adhere the beads or micro-beads to the open cell matrix.

Activated charcoal or activated carbon is a form of carbon processed from charcoal to have small, low-volume pores that increase the surface area (500 m² per gram) available for adsorption. Activated charcoal may be produced by physical reactivation wherein the carbon containing material is pyrolyzed at high temperature in the absence of oxygen and then exposed to an oxidizing atmosphere at high temperature. Another method known as chemical activation requires that the carbon containing material be impregnated a chemical such as phosphoric acid, potassium hydroxide, sodium hydroxide, calcium chloride or zinc chloride and then heated at high temperature.

In another embodiment, a fragrance may be impregnated into the open cell matrix to emit a desired odor continuously or when activated by moisture. U.S. Pat. No. 4,735,626 to Smith et al. discloses a polymer support impregnated with a fragrance. In this configuration, the fragrance is impregnated into the open cell matrix and instantly begins to emit a fragrance. The amount of time the fragrance will be detectible depends on the user's ability to sense the odor, amount of fragrance impregnated into the matrix, composition in which the fragrance is provided for impregnation, environment in which the insert is subjected during use and fragrance or fragrance composition's susceptibility to moisture from the beverage container. Given these considerations, one skilled in the art can determine how much of a fragrance to impregnate into the open cell matrix for the desired amount of usage time. Preferably, the fragrance utilized is a moisture activated fragrance. U.S. Pat. No. 5,626,852 to Suffis et al. discloses a moisture activated fragrance composition for use on skin. When the individual perspires the water solubilizes a base present in the composition that activates a high pH dependent fragrance. This type of composition may be utilized in a slow dissolving compound that subjects small amounts of the composition to moisture at a given time. In addition to the considerations listed above for a fragrance, the amount of time the moisture activated fragrance will be detectible also depends on the dissolving rate of the compound containing the composition. However, one skilled in the art can determine how much of a fragrance to impregnate into the open cell matrix for the desired amount of usage time or conduct a reasonable number of experiments to determine the usage time for a given compound containing a specific composition.

### 2. Configuration

The present invention includes three configurations in which the present invention may be prepared for use in a vehicle beverage holder. These are the insert which is planar and is placed at the base of the beverage holder; the band, which is tubular and fits about the beverage container, interfaces with the sides of the beverage holder reducing the amount of moisture from the sides of the beverage container reaching the base of the beverage holder; and the sleeve which combines both the insert and band, surrounds both the base and sides of the beverage container preventing moisture from reaching and accumulating in the base of the beverage holder.

The insert may be prepared from any of the open cell matrix materials disclosed above: without modification; comprising apertures of varying sizes, shapes and density; a moisture barrier; and/or impregnated with anti-bacterial agents, odor reducing compounds and/or fragrances that emit continuously or are moisture activated. The insert is prepared in a shape that allows it to fit easily in the base of the beverage holder. Preferably, the insert conforms to the shape and size of the base of the beverage holder although this is not a requirement. The insert may be prepared from sheet stock and cut into the desired shape and diameter.

To allow for easy placement, removal and replacement, the insert may further comprise one or more tabs that extend from the perimeter edge of the insert and extend upward along the sides of the holder when the insert is positioned in the base of the beverage holder. The shape and length of the tab may vary and will depend on the configuration of the specific vehicle beverage holder. For example, if the beverage holder is shallow, from about 25 mm to 50 mm in depth, the tabs may be semicircular and extend from 5 mm to 15 mm from the perimeter edge of the insert. At shallower depths it is not difficult to grasp a shorter tab, correspondingly, if the beverage holder is deep, a longer tab may be beneficial. For example, if the beverage holder is from 50 mm to 100 mm in depth, the tabs may extend from 15 mm to 30 mm and having a more oval or elongated oval shape.

The reusable absorbent insert may be cut from the matrix material so that it comprises a tab or “pull tab” at one or more locations along the perimeter edge. That tab may be rubberized and that rubberized material may also contain and dispense a fragrance. In another configuration, the reusable absorbent insert is cut from the matrix material as a circular disk to which a rubber pull tab is attached at one or more locations along the perimeter edge. Like the previous configuration, the rubber pull tab may also comprise and dispense a fragrance. In yet another configuration, the reusable absorbent insert is a circular disk to which both ends of a string are attached forming a small loop as a pull tab. One or more of these looped pull tabs may be affixed to the perimeter edge of the insert. Affixing the rubber pull tab and or the looped pull tab may be by adhesive, fusion or by other method known to those skilled in the art.

The band may be prepared from any of the open cell matrix materials disclosed above: without modification;

comprising apertures of varying sizes, shapes and density; a moisture barrier; and/or impregnated with anti-bacterial agents, odor reducing compounds and/or fragrances that emit continuously or are moisture activated. The band is prepared in a shape that allows it to fit easily over the base and snugly against the side of a beverage container. When used in conjunction with the vehicle beverage holder, the band prevents a majority of the moisture that may develop on the sides of the beverage container from reaching the base of the holder.

The band may be prepared from a circular stock material or sheet stock. If circular stock material is used the appropriate diameter is selected and cut to the desired width. If the band is prepared from sheet stock a length of a desired width is cut and the ends sewn together to produce a tubular configuration of the appropriate diameter. Since the height and diameter of beverage containers vary, the width and diameter of the band will also vary depending on the beverage container being used. For example, a can of soda has a diameter of approximately 60 mm and a height of approximately 120 mm. Consequently, the width of the band could range from approximately 50% to 80% the height of the beverage container (about 30 mm to about 48 mm) and have a diameter slightly less than the diameter of the beverage can to allow the open cell matrix to stretch applying pressure to the sides of the can and maintaining the band in place. In one embodiment of this configuration, the band may further comprise one or more straps that extend over the top and/or base of the beverage container to assist in placing or removing the band from the beverage container and in maintaining the band in place during use. The ends of the strap may be secured to the perimeter edge of the band and made of a semi-flexible material. Alternatively, one end of the strap may be affixed to the perimeter edge of the band and the other having a securing means for attachment to the opposite side of the band. The securing means may be any means known to those skilled in the art for securing the end of the strap to the band such as a snap or Velcro™.

A number of beverage containers have tapered sides that are narrower at the base. Consequently, the use of a strap affixed over the top of the container may be beneficial to prevent the band from sliding off when removing the container from the vehicle beverage holder. The strap may be affixed to the band so that it may be positioned over the top or lid of the beverage container. Alternatively, there may be two straps such that they are parallel when in place with each positioned slightly off center and to one side of the beverage container top or lid. Other configurations of two or more straps may also be considered by those skilled in the art for this purpose.

The sleeve may be prepared from any of the open cell matrix materials disclosed above: without modification; comprising apertures of varying sizes, shapes and density;

a moisture barrier; and/or impregnated with anti-bacterial agents, odor reducing compounds and/or fragrances that emit continuously or are moisture activated. The sleeve is prepared in a shape that allows the base and sides of the beverage container to be encased by the open cell matrix material. It also allows the beverage container and sleeve to be easily fitted within the vehicle beverage holder. When in use the sleeve prevents moisture that may develop on the base and sides of the beverage container from reaching the base of the holder.

The sleeve is a combination of the insert and band configurations. It may be prepared from sheet stock, sheet and tubular stock or fabricated directly in desired cup-shape. If the sleeve is prepared from sheet stock the base of the desired diameter and the side panel of the desired length and width are cut and then sewn together forming a cup-shape. If sheet and tubular stock are used to prepare the sleeve the base of a desired diameter and tubular stock of the same diameter and desired width are cut and the base sewn on one end of the tubular stock. If the sleeve is formed directly into the desired shape the open cell matrix material may be deposited on a form mold having the desired diameter and height of the base of a beverage container. When molding is completed the sleeve is removed from the form mold for further manipulation or use.

In this configuration, the perimeter edge of the sleeve may further comprise one or more tab and/or one or more straps. The one or more tabs may be utilized to assist in fitting the sleeve over the base of the beverage container or to remove the sleeve from the vehicle beverage holder. The one or more straps may be helpful in retaining the sleeve on the beverage container during use.

In each of the configurations of the present invention the perimeter edge may further comprise a flexible polymer lip to maintain their planer or tubular shape. For example, the flexible polymer lip on the insert helps to maintain the insert in a relatively planar shape reducing or preventing folding. The flexible polymer lip on one or both perimeter edges of the band or perimeter edge of the sleeve assist in maintaining the generally tubular shape of these configurations.

The flexible polymer may be made from a variety of materials that allow the inserts to be easily compressed by hand to remove moisture, revert back to their original shape after compression, resist folding in a planar configuration, resist collapse in a tubular configuration and resist separation from the open cell matrix material during use. For example, the flexible polymer may be neoprene or other similar type polymer. The cross-sectional profile of the flexible polymer may be circular, oval, square, rectangular or any other geometric shape desired. In one embodiment, the flexible polymer is provided in a shape that has a tapered ascending skirt whose top edge fits flush up against the walls of the beverage holder.

This configuration prevents debris from collection in the corners of the base of the beverage holder by directing the debris to the insert for removal when the insert is cleaned and replaced. The polymer may be affixed to the edge of the insert by a variety of methods known to those skilled in the art including adhesive, fusion, or forming the polymer directly on the edge of the open cell matrix.

### Use

If an owner is having difficulty with the accumulation of moisture in one or more beverage holders in a vehicle, the owner selects a desired configuration. If the insert is selected it is removed from the packaging and placed in the base of the beverage holder by inserting into the holder and pressing the edges of the insert into the corners of the base of the holder. When the insert contains moisture it may be removed by grasping one of the tabs along the perimeter edge and pulling upward. The insert may then be squeezed by hand to remove the moisture and replaced in the beverage holder. Alternatively, the insert may be hand or machine washed and dried before replacing in the beverage holder.

Unlike the insert, the band and sleeve are fitted about the beverage container and the container is then inserted into the beverage holder. If the band or sleeve contains one or more straps they may be fitted over the top or lid of the beverage container to assure that the insert remains in place when the beverage container is removed and replaced in the beverage holder. In addition, one or more tabs may be provided along the perimeter edge of the sleeve or the upper perimeter edge of the band to assist in fitting the device over the beverage container and to remove the device from the beverage holder if needed.

One or more of the surfaces of the inserts of the present invention may be utilized for advertising. For example, the beverage container contact surface of the insert and the outer beverage holder contact surface of the band and sleeve may contain logos, designs, advertising, patterns or colors that may be of interest to the user.

I claim:

1. A reusable absorbent insert for a vehicle beverage holder comprising an open cell matrix material with a beverage container contact surface, a beverage holder contact surface and a perimeter edge having a shape that fits within the base of said vehicle beverage holder and having at least one tab along said perimeter edge to enable easy placement, removal and replacement of said absorbent insert in said vehicle beverage holder.

2. The reusable absorbent insert according to claim 1, wherein said open cell matrix comprises a plurality of apertures to increase surface area for absorption and evaporation of fluid.

3. The reusable absorbent insert according to claim 1, further comprising a moisture barrier on said beverage holder contact surface.

4. The reusable absorbent insert according to claim 1, further comprising a flexible polymer along said perimeter edge to maintain the configuration of said insert.

5. The reusable absorbent insert according to claim 4, wherein said at least one tab is made of a flexible polymer and provided within said flexible polymer along said perimeter edge.

6. The reusable absorbent insert according to claim 1, further comprising an antibacterial agent within said open cell matrix material.

7. The reusable absorbent insert according to claim 6, wherein said antibacterial agent is a silver compound.

8. The reusable absorbent insert according to claim 1, further comprising an activated charcoal within said open cell matrix material.

9. The reusable absorbent insert according to claim 1, further comprising a fragrance within said open cell matrix material.

10. The reusable absorbent insert according to claim 9, wherein said fragrance is activated by moisture.

11. The reusable absorbent insert according to claim 1, wherein said open cell matrix material is synthetic chamois.

12. A reusable absorbent sleeve for a beverage container and a vehicle beverage holder comprising an open cell matrix material with an inner beverage container contact surface, an outer beverage holder contact surface, a base and an upper perimeter edge said sleeve having a shape that fits about said beverage container and within said vehicle beverage holder with all or a portion of said outer beverage holder contact surface having a moisture barrier and said upper perimeter edge having at least one tab to enable easy placement on and removal from said beverage container and/or removal from said vehicle beverage holder.

13. The reusable absorbent sleeve according to claim 12, further comprising a flexible polymer edge on said upper perimeter edge to maintain said absorbent sleeve in a semi-cylindrical shape.

14. The reusable absorbent sleeve according to claim 12, wherein said moisture barrier has an open cell matrix material contact surface and an outer surface and further wherein said outer surface is textured.

15. The reusable absorbent sleeve according to claim 12, wherein said base further comprises an antibacterial agent within said open cell matrix material.

16. The reusable absorbent sleeve according to claim 15, wherein said antibacterial agent is a silver compound.

17. The reusable absorbent sleeve according to claim 12, wherein said base further comprises an activated charcoal within said open cell matrix material.

18. The reusable absorbent sleeve according to claim 12, wherein said open cell matrix comprises a plurality of apertures to increase surface area for absorption and evaporation of fluid.

19. The reusable absorbent sleeve according to claim 12, further comprising a fragrance within said open cell matrix material.

20. The reusable absorbent sleeve according to claim 19, wherein said fragrance is activated by moisture.

21. The reusable absorbent insert according to claim 12, wherein said open cell matrix material is synthetic chamois.

22. A reusable absorbent band for a beverage container and a vehicle beverage holder comprising an open cell matrix material with an inner beverage container contact surface, an outer beverage holder contact surface, a top perimeter edge and a bottom perimeter edge having a shape that fits about said beverage container and within said vehicle beverage holder and having a moisture barrier on said outer beverage holder contact surface.

23. The reusable absorbent band according to claim 22, further comprising a flexible polymer on at least one of said perimeter edges to maintain said absorbent band in a semi-cylindrical shape.

24. The reusable absorbent band according to claim 22, wherein said moisture barrier has an open cell matrix contact surface and an outer surface and further wherein said outer contact surface is textured.

25. The reusable absorbent band according to claim 22, further comprising a strap having two ends affixed to said upper perimeter edge about 180 to about 270 degrees distant from each other to loop over the top of said beverage container maintaining said absorbent band in place during use.

26. The reusable absorbent band according to claim 22, wherein said open cell matrix comprises a plurality of apertures to increase surface area for absorption and evaporation of fluid.

27. The reusable absorbent band according to claim 22, further comprising a fragrance within said open cell matrix material.

28. The reusable absorbent band according to claim 27, wherein said fragrance is activated by moisture.

29. The reusable absorbent insert according to claim 22, wherein said open cell matrix material is synthetic chamois.
